(19) United States
(12) Patent Application Publication
(10) Pub. No.: US 2010/0192107 A1
(43) Pub. Date: Jul. 29, 2010

(54) SHARED INFORMATION DISPLAY DEVICE, SHARED INFORMATION DISPLAY METHOD, AND COMPUTER PROGRAM

(75) Inventor: Yusuke Takahashi, Matsumoto-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Tokyo (JP)

(21) Appl. No.: 12/691,699

(22) Filed: Jan. 21, 2010

(30) Foreign Application Priority Data
Jan. 23, 2009 (JP) 2009-012535

(51) Int. Cl. G06F 3/048

(52) U.S. Cl. 715/856

(57) ABSTRACT

A shared information display device includes a work information managing section that receives work content data and cursor operation signals from the plurality of users, a display section that simultaneously displays an image of the work content data and cursor images of the plurality of users, and a cursor moving section that moves a cursor image of each user. The shared information display device includes a user attribute information section that acquires or stores user attribute information of each of the plurality of users, and a cursor image preparing section that prepares a cursor image of each user thereof on the basis of the user attribute information, wherein the display section displays the cursor image of each user prepared by the cursor image preparing section on the display screen.

### BACKGROUND

1. Technical Field

The present invention relates to a shared information display device which electronically displays a shared file or document on a display screen so as to enable participants to share, refer to, or edit the same file or document for a conference or collaborative work in which a plurality of persons participate, and more particularly, to a technique for making it possible to easily identify the operation cursor of each participant on a display screen.

2. Related Art

In the past, for example, the subject of discussion in a conference has been a distributed document, a document projected onto a screen by an image projector, or writing on a whiteboard. During the discussion, all participants share important content when a participant writes important content on the whiteboard or a user of a personal computer connected to an image projector representatively writes important content to an electronic file. After the conference, the writing on the whiteboard is printed using a printer or the like attached to the whiteboard and printed records are distributed to the participants.

In order to make the conference process efficient, it is known that a shared display device and a terminal device of each participant are connected to a network, a shared screen is manipulated by the operation of each terminal device, the conference proceeds while performing mouse operations or character input, and conference records are completed as electronic data or desired data are merged when the conference ends (for example, JP-A-11-65975 and JP-A-2007-213511).

In the manipulation of the shared screen, a plurality of users arranges, and simultaneously operate, pointing cursors on one screen or window. In this situation, it is difficult to identify who is the user of each cursor. To clearly identify which terminal device indicates a work point on the shared screen, there is known a technique of arranging an image representing each user on the shared screen and extending a cursor at a work point as the point of origin (for example, JP-A-2001-157184).

The display technique disclosed in JP-A-2001-157184 has the following problems. First, an image representing each user on the shared screen is necessary. Work space on the shared screen is reduced by the space displaying the image. Second, the field of view for work content is obstructed since a cursor is extended by a positional relationship between an image representing a person and a work point.

### SUMMARY

An advantage of some aspects of the invention is that a shared information display device is able to arrange pointing cursors of participating users on a shared screen so as to facilitate the work.

According to a first aspect of the invention, there is provided a shared information display device including a work information managing section that receives work content data to be referred to or edited by a plurality of users and cursor operation signals from the plurality of users, a display section that simultaneously displays an image of the work content data and cursor images of the plurality of users on a display screen, and a cursor moving section that moves a cursor image of each user on the display screen in response to a cursor operation signal requesting cursor movement from each user. The shared information display device includes a user attribute information section that acquires or stores user attribute information indicating a user attribute value of each of the plurality of users, and a cursor image preparing section that prepares a cursor image of each user so that a display form of the cursor image of each user becomes a display form corresponding to a user attribute value thereof on the basis of the user attribute information, wherein the display section displays the cursor image of each user prepared by the cursor image preparing section on the display screen.

According to this configuration, a display form of a cursor image of each user is determined on the basis of a user attribute value of each user (for example, a name, an identification code, a nickname, a workplace to which the user belongs, a present location, a desired avatar image, a certain proposal to which the user agrees in a conference, image data of a desired cursor image, design information such as a color, a shape, or the like of the cursor image, or the like). Therefore, it is possible to more easily identify which cursor image is whose since user cursor images are displayed in different forms when user attribute values of a plurality of users are different from each other.

Here, in this specification, the “display form” of the cursor image is used as meaning including any of various visual features of a cursor image helping the user to distinguish each cursor image from other cursor images on the display screen such as the static visual appearance of a shape, a color, a design, a size, or the like of the cursor image displayed on the display screen, the dynamic visual appearance of the flickering or variation of the cursor image, a display position of the cursor image, and/or the variation of the display position of the cursor image.

The shared information display device according to the invention is capable of being constituted to determine a display form of a cursor image on the basis of only a user attribute value for one user attribute item (for example, image data of a cursor image desired by each user is directly used as a cursor image of each user), or is capable of being constituted to determine a display form of a cursor image on the basis of user attribute values for a plurality of user attribute items (for example, a shape of the cursor image is determined on the basis of a workplace to which each user belongs and a color of the cursor is determined in response to whether or not each user agrees to a certain proposal).

The shared information display device of the invention is capable of being constituted as follows. That is, it is preferable that the cursor image preparing section should include a grouping section that classifies the plurality of users into at least two groups on the basis of the user attribute information, wherein the cursor image preparing section prepares the cursor image of each user so that display forms of cursor images of users belonging to each group have a common feature corresponding to a common user attribute value of the group.

According to this configuration, a common feature of a cursor image of each user differs in response to a user group classified on the basis of a user attribute value. For example, a different display form is able to be determined for each user group so that cursor images of users belonging to the same workplace (group) are displayed in the same color (common feature).

The shared information display device of the invention is capable of being constituted as follows. That is, it is preferable to further include a display form changing section that determines whether or not the cursor operation signal from each user satisfies a predetermined condition and changes the display form of the cursor image of the user in response to a determination result.

According to this configuration, the display form of a cursor image is capable of being changed in response to the state of cursor operation by the user. For example, a cursor which has not moved for a predetermined time is capable of having its image reduced until it is inconspicuous.

In the shared information display device of the invention, it is preferable that the display form changing section should determine whether or not a cursor operation signal has been input from each user for a predetermined time, and move the cursor image of that user to a predetermined area on the display screen when the cursor operation signal has not been input from each user for the predetermined time.

According to this configuration, a cursor image is automatically moved to a predetermined area where the cursor operation of another user is not obstructed (for example, an area close to a corner of the display screen or an area outside an active window) when the cursor operation is absent.

The shared information display device of the invention is capable of being constituted as follows. That is, it is preferable that the shared information display device should be included in a first terminal device communicable with a second terminal device 5b via a communication network, the work information managing section should receive a cursor operation signal from a first user input to the first terminal device and a cursor operation signal from a second user input to the second terminal device 5b, and the user attribute information should include a user attribute value of the first user and a user attribute value of the second user.

According to this configuration, when a plurality of terminal devices (for example, personal computers) respectively used by a plurality of users are connected to be communicable via a communication network, it is possible to mount the shared information display device according to the invention on at least one of the terminal devices (in other words, at least one terminal device described above functions as the shared information display device). The shared information display device mounted on the at least one terminal device is capable of receiving cursor operation signals from the plurality of terminal devices and displaying cursor images of the plurality of users on the display screen. In this case, the shared information display device may enable each terminal device to display the cursor images of the plurality of users by transmitting the cursor images of the plurality of users to other terminal devices.

Alternatively, the shared information display device may be mounted on each of the terminal devices of the plurality of users connected to be communicable via the communication network (in other words, a terminal device of each user functions as the shared information display device according to the invention). Shared information display devices respectively mounted on the plurality of terminal devices are capable of mutually communicating cursor operation signals, and displaying a shared work content data image and cursor images of the plurality of users on each display screen.

Even in any case described above, each shared information display device may make a cursor image display form of a user of the shared information display device different from cursor image display forms of other terminal devices.

According to this configuration, the shared information display device of the terminal device of each user makes the cursor image of the user different from cursor images of other users. For example, only the cursor image of the user is able to be set to a more distinctive image by setting the cursor images of the other users to simple images. This enables each user to distinguish their own cursor from cursors of the other users.

Even in any case described above, each shared information display device may make a display form of a cursor image of a user of the shared information display device different from a display form of another cursor image when the position of the cursor image of the user of the shared information display device and the position of the cursor image of another user are in the same predetermined area.

According to this configuration, the shared information display device of the terminal device of each user makes the cursor image of the user different from cursor images of other users when a plurality of cursors are densely clustered in a place on a display screen. In this way, it is possible for each user to easily identify their own cursor from the cursors of the other users by reconfiguring cursor images.

Even in any case described above, each shared information display device acquires a user attribute value for a predetermined user attribute item of another user from user attribute information to display the acquired user attribute value on a display screen when a cursor operation signal requesting information regarding a cursor of the other user has been input as a cursor operation signal from a user of the shared information display device.

According to a second aspect of the invention, there is provided a shared information display method including receiving work content data to be referred to or edited by a plurality of users and cursor operation signals from the plurality of users, simultaneously displaying an image of the work content data and cursor images of the plurality of users on a display screen, and moving a cursor image of each user on the display screen in response to a cursor operation signal requesting cursor movement from each user. The shared information display method includes: acquiring or storing user attribute information indicating a user attribute value of each of the plurality of users; and preparing a cursor image of each user so that a display form of the cursor image of each user becomes a display form corresponding to a user attribute value thereof on the basis of the user attribute information, wherein the cursor image of each user prepared by the cursor image preparing section is displayed on the display screen.

According to a third aspect of the invention, there is provided a program for making a computer execute a shared information display method including receiving work content data to be referred to or edited by a plurality of users and cursor operation signals from the plurality of users, simultaneously displaying an image of the work content data and cursor images of the plurality of users on a display screen, and moving a cursor image of each user on the display screen in response to a cursor operation signal requesting cursor movement from each user. The shared information display method includes: acquiring or storing user attribute information indicating a user attribute value of each of the plurality of users; and preparing a cursor image of each user so that a display form of the cursor image of each user becomes a display form corresponding to a user attribute value thereof on the basis of the user attribute information, wherein the cursor image of each user prepared by the cursor image preparing section is displayed on the display screen.

According to the invention, it is possible for each user to more easily determine which is its own cursor or whose cursor image it is since a cursor image display form of each user displayed on a shared information display device is defined in response to a user attribute value of each user.

### BRIEF DESCRIPTION OF THE DRAWINGS

The invention will be described with reference to the accompanying drawings, wherein like numbers reference like elements.

FIG. 1 is a system configuration diagram showing the configuration of a shared information display system using a shared information display device according to an embodiment of the invention.

FIG. 2 is a functional block diagram showing functions of the shared information display device according to the embodiment of the invention in the shared information display system shown in FIG. 1.

FIG. 3 is a sequence diagram showing the flow of a basic operation of the shared information display system shown in FIG. 1.

FIG. 4 is a diagram showing an example of user attribute information to be managed by a large size display device.

FIG. 5 is a flowchart showing the flow of a cursor image preparation process to be executed by the large size display device.

FIG. 6 is a diagram showing a display screen example when the large size display device groups users according to an affiliation department and a cursor image of each user is prepared on the basis of a group.

FIG. 7 is a diagram showing a display screen example when the large size display device prepares a cursor image of each user on the basis of an avatar image file of each user.

FIG. 8 is a diagram showing a display screen example when the large size display device prepares a cursor image of each user on the basis of a cursor image file of each user.

FIG. 9 is a sequence diagram showing the flow of an operation of changing a cursor display form when a cursor has not been operated for a given time.

FIG. 10 is a diagram showing a display screen example when the cursor display form is changed when the cursor has not been operated for the given time.

FIG. 11 is a diagram showing a display screen example in which the cursor display form is changed when the cursor operation has been resumed.

FIG. 12 is a diagram showing another display screen example in which the cursor display form is changed when the cursor has not been operated for the given time.

FIG. 13 is a flowchart showing a process flow when a certain terminal device causes another user cursor located close to the user cursor of its own device to be displayed in its simple form.

FIG. 14 is a diagram showing a display screen example when a certain terminal device causes another user cursor located close to the user cursor of the terminal device to be displayed in its simple form.

FIG. 15 is a diagram showing a display screen example when a terminal device separated from the figure causes another user cursor located close to the user cursor of its own device to be displayed in its simple form.

FIG. 16 is a sequence diagram showing the flow of a process in which the user of a certain terminal device refers to information of another user in the terminal device.

FIG. 17 is a diagram showing a display screen example when the user of a certain terminal device refers to information of another user in the terminal device.

### DESCRIPTION OF EXEMPLARY EMBODIMENTS

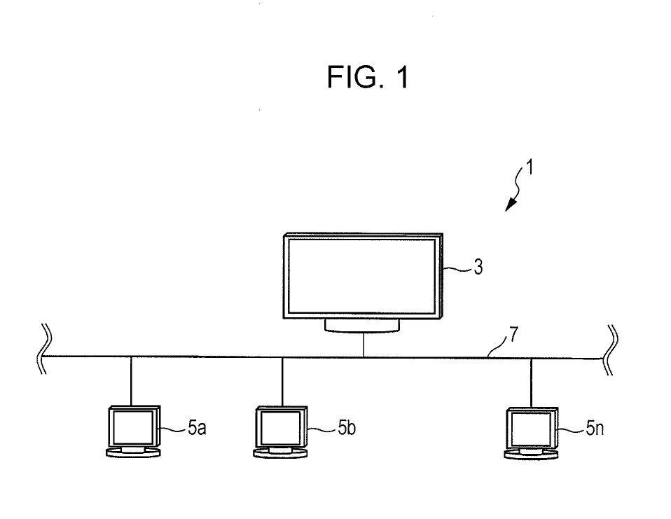

Hereinafter, an embodiment of a shared information display device according to the invention will be described in detail with reference to drawings. FIG. 1 shows a configuration example of a shared information display system using the shared information display device.

A shared information display system 1 is adapted to enable a plurality of users (conference participants) to refer to or collectively edit the same work content (for example, electronic data such as conference records, presentation data, or the like) in a conference or collaborative work, and includes one large size display device 3 and a plurality of terminal devices 5a, 5b, and 5n which are connected to a communication network 7 so that they can communicate with each other.

The large size display device 3 has a display device capable of displaying a large screen such as a flat panel display, an electronic whiteboard, a liquid crystal image projector, or the like. For example, the large size display device 3 is installed in a conference room or the like, and enables the users to view together information displayed on the large screen.

Each of the terminal devices 5a, 5b, and 5n is a portable or desktop computer (for example, a portable personal computer or portable phone carried by each user in the conference room, a personal computer used in the office of each user, or any device), and functions as the shared information display device according to the embodiment of the invention by executing a program installed therein.

The large size display device 3 is one computer available as one terminal device like the terminal devices 5a, 5b, and 5n, and functions as the shared information display device according to the embodiment of the invention by executing a program installed therein.

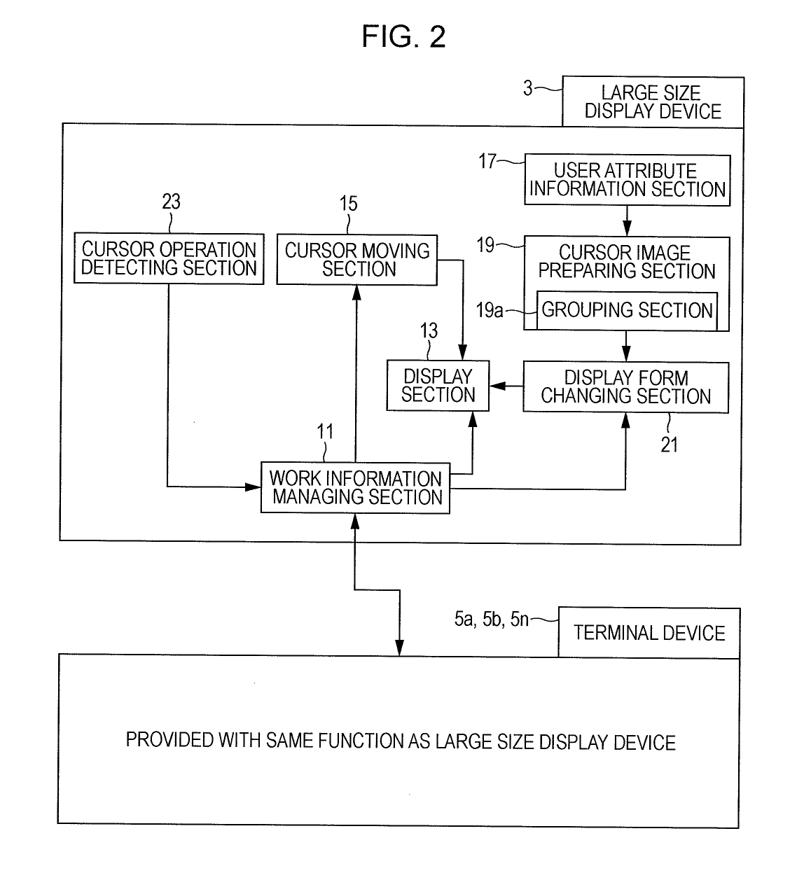

FIG. 2 is a functional block diagram showing functions of the shared information display device according to the embodiment of the invention in the shared information display system shown in FIG. 1.

The large size display device 3 and all the terminal devices 5a, 5b, and 5n function as the shared information display device according to the embodiment of the invention, and have basically the same configuration as the shared information display device. Representatively, only a functional configuration as the shared information display device provided in the large size display device 3 is shown in FIG. 2. The large size display device 3 includes a work information managing section 11, a display section 13, a cursor moving section 15, a user attribute information section 17, a cursor image preparing section 19, a grouping section 19a attached to the cursor image preparing section 19, a display form changing section 21, and a cursor operation detecting section 23.

The work information managing section 11 receives work content data to be referred to or edited by a plurality of users and cursor operation signals from the plurality of users. An input source of work content data may be the large size display device 3 itself (a storage device (not shown) provided in the large size display device 3), each of the terminal devices 5a, 5b, and 5n, or an arbitrary external device (not shown in FIG. 1) communicable with the large size display device 3. An input source of a cursor operation signal from each user is the terminal device used by each user, for example, the terminal devices 5a, 5b, and 5n, and the large size display device 3 itself (the cursor operation detecting section 23 provided in the large size display device 3). The work information managing section 11 sends the input work content data to the display section 13 and sends the input cursor operation signal of each user to the cursor moving section 15 and the display form changing section 21.

The display section 13 has a display screen, receives the work content data from the work information managing section 11, and displays an image of the work content data on the display screen. The display section 13 receives cursor images of a plurality of users prepared by the cursor image preparing section 19, and simultaneously displays the cursor images and the work content data image on the display screen.

The cursor moving section 15 receives a cursor operation signal of each user from the work information managing section 11 and controls the display section 13 in response to a cursor operation signal requesting cursor movement among cursor operation signals, thereby moving the cursor image of each user on the display screen.

The user attribute information section 17 acquires user attribute information (for example, a name, an identification code, a nickname, a workplace to which the user belongs, a present place, a desired avatar image, a certain proposal to which the user agrees in a conference, image data of a desired cursor image, design information such as a color, a shape, or the like of the cursor image, or the like) indicating a user attribute value of each of the plurality of users from an arbitrary external device or receives the user attribute information in an arbitrary method, and stores the user attribute information. In the user attribute information, the user attribute value of each user is written for at least one user attribute item (for example, a name, an identification code, a nickname, a workplace to which the user belongs, a present place, a desired avatar image, a certain proposal to which the user agrees in a conference, image data of a desired cursor image, design information such as a color, a shape, or the like of the cursor image, or the like).

The cursor image preparing section 19 prepares or creates the cursor image of each user so that a display form of the cursor image of each user becomes a display form corresponding to the user attribute value on the basis of the user attribute information. In general, cursor images having different display forms are prepared by the users since user attribute values by the users are different. Here, the “display form” of the cursor image is the meaning including any of various visual features of a cursor image helping the user to distinguish each cursor image from other cursor images on the display screen such as the static visual appearance of a shape, a color, a design, a size, or the like of the cursor image displayed on the display screen, the dynamic visual appearance of the flickering or variation of the cursor image, a display position of the cursor image, and/or the variation of the display position of the cursor image.

As a method of determining a display form of the cursor image of each user by the cursor image preparing section 19, the display form of the cursor image may be determined on the basis of only a user attribute value for one user attribute item (for example, image data of a cursor image desired by each user is directly used as a cursor image of each user), or the display form may be determined on the basis of user attribute values for a plurality of user attribute items (for example, a shape of the cursor image is determined on the basis of a workplace to which each user belongs and image data thereof is used as a cursor image of each user).

The cursor image preparing section 19 has the grouping section 19a. The grouping section 19a classifies a plurality of users into two or more groups on the basis of the user attribute information. As a grouping method, for example, users are capable of being grouped by an affiliation department or agreement or disagreement for a certain proposal on the basis of user attribute values of one or more predetermined attribute items. The cursor image preparing section 19 is capable of preparing the cursor images of each user so that each group has a common feature corresponding to a common user attribute value. For example, shapes and colors of the cursor images of the users belonging to the same group are set to be the same and those are set to be different between groups.

The display form changing section 21 has a function of determining whether or not a cursor operation signal from each user satisfies a predetermined condition (for example, whether the cursor operation signal is a cursor operation signal input to a shared information display device (the large size display device 3 in this example) in which the cursor of which the cursor operation has not been performed for at least a predetermined time exists in the same area as those of other cursors on the display screen, or a cursor operation signal input to another shared information display device (the terminal device 5a, 5b, or 5n in this example), or whether a specific type of cursor operation has been requested) and changing the display form of the cursor image of the user according to the determination result. For example, the display form changing section 21 moves a cursor which has not moved for a predetermined time to a standby place, or distinctively displays a cursor of a decider having the right to decide decision content.

The cursor operation detecting section 23 detects the cursor operation signal input from the user to the shared information display device (in this case, the large size display device 3), and transmits the detected cursor operation signal to the work information managing section 11.

A functional configuration as the shared information display device provided in each of the terminal devices 5a, 5b, and 5n is the same that of the large size display device 3. In this regard, the cursor operation detecting section 23 of each of the terminal device 5a, 5b, and 5n detects a cursor operation signal input to each of the terminal devices 5a, 5b, and 5n. A type of content of the user attribute information provided in the user attribute information section 17 of each of the terminal devices 5a, 5b, and 5n, a method in which the cursor image preparing section 19 determines the display form of the cursor image on the basis of the user attribute information, and/or a method in which the display form changing section 21 changes the display form of the cursor image may be different between the terminal devices 5a, 5b, and 5n, or may be common. Alternatively, each of the terminal devices 5a, 5b, and 5n may receive a cursor image prepared by another specific shared information display device, for example, the large size display device 3, from the large size display device 3 and may display the cursor image in the same display form as that of the large size display device 3 without enabling the user attribute information section 17 or the cursor image preparing section 19 of its own device to function.

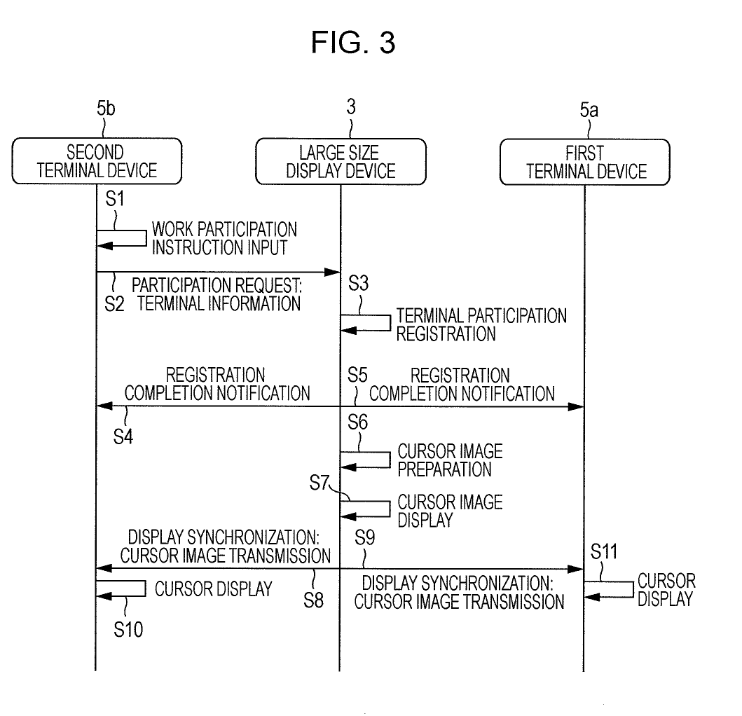

FIG. 3 is a sequence diagram showing the flow of a basic operation of the shared information display system shown in FIG. 1. That is, for example, this figure shows the flow of a cursor image display process in each device when the large size display device 3 and the first terminal device 5a (a plurality of terminal devices may be possible) have already participated in a collaborative work (for example, a conference), and the second terminal device 5b newly participates in the collaborative work. In this example, it is assumed that a cursor image is prepared by the large size display device 3 and is transmitted to the other terminal devices 5a and 5b to share the cursor image.

As shown in FIG. 3, the large size display device 3 and the first terminal device 5a already perform the collaborative work. At this time, an image of work content as an object of the collaborative work, a cursor image of a user of the large size display device 3, and a cursor image of a user of the first terminal device 5a are displayed on a display screen of each of the large size display device 3 and the first terminal device 5a, and a cursor image of the user of each of the large size display device 3 and the first terminal device 5a has the display form corresponding to the user attribute value of each user. At this time, terminal information of the second terminal device 5b (including identification information (a terminal name and/or a network address) of the second terminal device 5b and user identification information (a user ID and/or name)) is transmitted as a participation request from the second terminal device 5b to the large size display device 3 (step S2), when the user performs a work participation instruction input operation (for example, a login operation for the collaborative work by inputting a user ID of the user) in the second terminal device 5b (step S1).

Then, the large size display device 3 performs a participation registration process for the collaborative work of the user with the second terminal device 5b (that is, registers the user as one participant of the collaborative work by linking the identification information of the second terminal device 5b and the identification information of the user included in the terminal information to each other) (step S3), sends a registration completion notification to the second terminal device 5b (step S4), and notifies the first terminal device 5a of the fact that the second terminal device 5b has been completely registered (step S5).

The large size display device 3 prepares or creates a cursor image of the second terminal device 5b (step S6), and displays the prepared cursor image of the second terminal device 5b on its own display screen (step S7). When the cursor image of the second terminal device 5b is prepared, the large size display device 3 identifies the user of the second terminal device 5b on the basis of terminal information from the second terminal device 5b (for example, on the basis of user identification information included in the terminal information, for example, a user ID), acquires a user attribute value taken in a predetermined attribute item of the identified user (corresponding to the user ID of the user, for example) from the acquired and stored user attribute information in advance, and prepares the cursor image of the user of the second terminal device 5b on the basis of the user attribute value so that the display form of the cursor image of the user corresponds to the user attribute value.

The large size display device 3 transmits the work content image and the cursor image of the user of each of the large size display device 3 and the terminal devices 5a and 5b to the second terminal device 5b so as to acquire display synchronization among the large size display device 3 and the terminal devices 5a and 5b (step S8), and also transmits the cursor image of the user of the second terminal device 5b to the first terminal device 5a (Step S9).

The second terminal device 5b displays cursor images of all users participated in the collaborative work (step S10), and the first terminal device 5a also displays the cursor images of all the participation users (step S11). In this way, when the user of the second terminal device 5b participates in the collaborative work later, the cursor of the second terminal device 5b is displayed by the large size display device 3 or another terminal device (the first terminal device 5a) already participated in the collaborative work.

This example is the case where the large size display device 3 creates cursor images of participation users as a whole, but instead the large size display device 3 and the terminal devices 5a and 5b may mutually communicate a cursor operation signal input from the user of its own device and each of the devices 3, 5a, and 5b may independently create cursor images of all the users on the basis of cursor operation signals of its own device and the other devices.

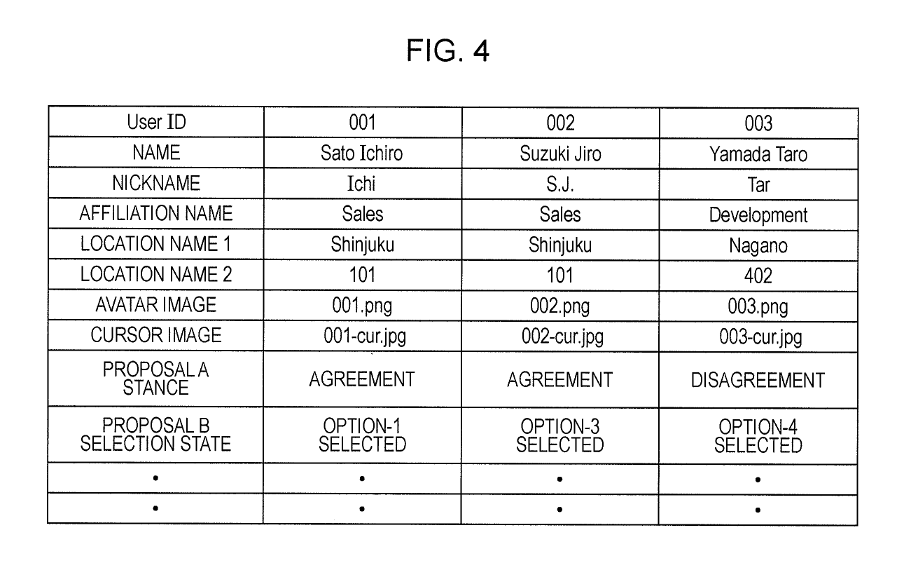

FIG. 4 is a diagram showing an example of user attribute information to be managed by the large size display device.

For example, the user attribute information is stored in the form of a table as shown. For example, a user ID, a name, a nickname, an affiliation name, a location name 1, a location name 2, an avatar image, a cursor image, a stance for Proposal A, a Proposal B selection situation, and the like are included therein. For example, user attribute information in which the name is “Sato Ichiro”, the nickname is “Ichi”, the affiliation name is “Sales”, the location name 1 is “Shinjuku”, the location name 2 is “101”, the avatar image is “001.png”, the cursor image is “001-cur.jpg”, the stance for Proposal A is “Agreement”, and the Proposal B selection situation is “Option 1 Selected” are registered as user attribute values for the user for whom the user ID is “001”. In general, when users are different, user attribute values of attribute items are different (for example, the user attribute values of the user ID, the name, the nickname, the avatar image, and the cursor image are different between the users in the shown example). Thus, the display form of the cursor image of each user is determined on the basis of the user attribute values of predetermined attribute items (for example, the nickname, the avatar image, and/or the cursor image), so that it is possible to identify the user from the display form of the cursor image. The user attribute value of the attribute item such as the user ID or name is unique for each user and hence may be used as the user identification information described in the flow shown in FIG. 3.

Since the cursor image of the user can be displayed in the unique display form of the user, regardless of a terminal device used by the user, by determining the display form of the cursor image of each user according to the unique user attribute value as shown in FIG. 4, user identification is further facilitated as compared with the case where the display form of the cursor image depending upon the terminal device is determined.

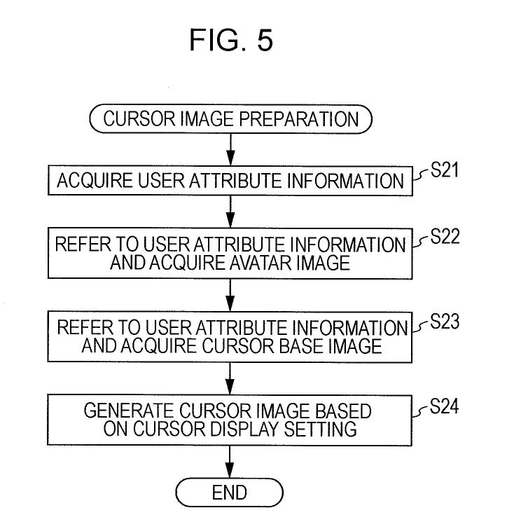

FIG. 5 is a flowchart showing the flow of a cursor image preparing process to be executed by the large size display device 3. That is, this figure shows the process flow when the large size display device prepares an avatar image in step S6 of the sequence of FIG. 3.

As shown in FIG. 5, the large size display device 3 acquires the user attribute information shown in FIG. 4 (step S21). The user attribute information shown in FIG. 4 may be directly input in advance to the large size display device 3, or the large size display device 3 may acquire the user attribute information from each of the terminal devices 5a, 5b, and 5n or another external terminal device.

Next, in the case where the work of preparing a cursor image of each participation user is conducted, the large size display device 3 identifies the user from terminal information (for example, a user ID “001” included in the terminal information) when the user has performed a participation registration process for the collaborative work, refers to the acquired user attribute information of FIG. 4, and acquires the user attribute values of predetermined attribute items, for example, an image file “001.png” of the avatar image and an image file “001-cur.jpg” of the cursor image (steps S22 and S23). The cursor image of the user (for example, a cursor image obtained by combining the cursor image of the image file “001-cur.jpg” and the avatar image of the image file “001.png”) is generated according to an image creation method defined by cursor display setting set in advance using the acquired user attribute values, for example, the image file “001.png” of the avatar image and the image file “001-cur.jpg” of the cursor image (step S24).

As a modified example, not only the large size display device 3 may only prepare cursor images in the process sequence shown in FIG. 5, but also each terminal device may prepare the cursor images in the same process sequence.

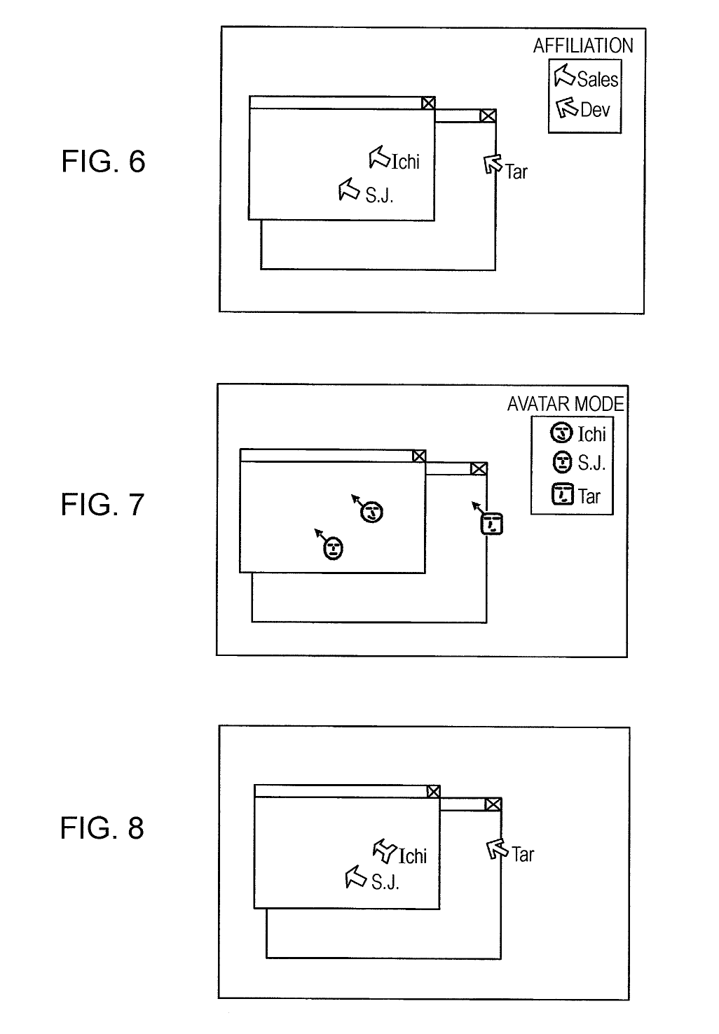

Various variations may be adopted to determine a display form of a cursor image according to how to use which attribute item. FIGS. 6 to 8 show the examples of the variations.

FIG. 6 shows a display screen example when the large size display device 3 groups users according to an affiliation department and prepares cursor images having a common display form for each group.

In the example of FIG. 6, the cursor image of each user is determined so that a cursor image shape for each affiliation department is set to be common in response to an affiliation department “Sales” or “Development (Dev)”. The explanatory note is shown within a rectangular frame attached to an affiliation shown in the upper right portion of the shown display screen.

As shown, cursor images of users belonging to the same group, that is, the same affiliation department “Sales”, are displayed in one common shape on a window displaying certain work content, and a cursor image of a user belonging to a different affiliation department “Dev” is displayed in a different common shape. This enables a correspondence relationship between a cursor and a group to be visually understood. The cursor images of the users include text images of nicknames created on the basis of the nicknames “Ichi”, “S. J”, and “Tar” of the users. This enables a correspondence relationship between a cursor and a user to be visually understood. In this example, it can be seen that cursor images are prepared on the basis of user attribute values of a plurality of attribute items called an affiliation department and a nickname.

The above-described grouping is performed by the grouping section 19a of the cursor image preparing section 19 shown in FIG. 2. That is, the grouping section 19a classifies a plurality of users into two or more groups on the basis of user attribute information, and the cursor image preparing section 19 prepares a cursor image of each user so that the display form of cursor images of users belonging to each group has a common feature corresponding to a user attribute value common in the group.

FIG. 7 shows a display screen example when the large size display device 3 prepares a cursor image on the basis of an avatar image.

As shown in FIG. 7, a cursor image of each user displayed on a display screen is prepared by combining an avatar image prepared on the basis of an image file of an avatar image of each user described in user attribute information illustrated in FIG. 4 and a given arrow image. This enables a correspondence relationship between a cursor and a user to be visually easily understood. The explanatory note of cursor images is shown on the upper right portion of the display screen, but text images of nicknames (“Ichi”, “S. J”, and “Tar”) of the users are displayed thereon, so that a correspondence relationship between a user and a cursor is more easily understood. As in the explanatory note, images (“Ichi”, “S. J”, and “Tar”) of nicknames or names of the users may be displayed even in the cursor images of the users displayed on the display screen.

FIG. 8 is a diagram showing a display screen example when the large size display device 3 prepares cursor images of users on the basis of unique cursor image files of the users.

As shown in FIG. 8, the cursor image of each user displayed on the display screen is prepared by combining a text image of a nickname of each user and a cursor image prepared on the basis of an image file of a cursor image of each user described in the user attribute information illustrated in FIG. 4. This enables a correspondence relationship between a cursor and a user to be visually easily understood.

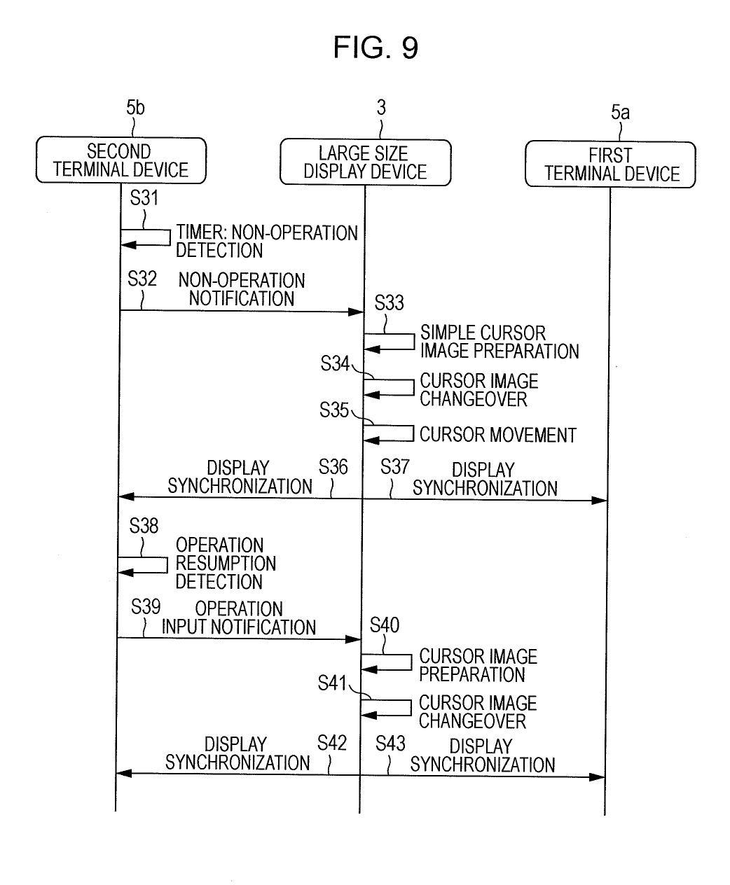

FIG. 9 shows the flow of an operation of changing a cursor display form when a cursor has not been operated for a given time. In the example of FIG. 9, it is assumed that the large size display device 3 performs a control process of changing the cursor display form and the control process result is sent to the other terminal devices 5a and 5b and shared.

As shown in FIG. 9, when the cursor operation detecting section 23 (see FIG. 2) of the second terminal device 5b uses a timer and detects that the cursor operation by the user of its own device is absent for a given time (step S31), a notification indicating that the cursor operation of the user is absent is transmitted from the second terminal device 5b to the large size display device 3 (wherein the notification includes information for enabling the large size display device 3 to identify the user like identification information of the second terminal device 5b and/or user identification information of the user) (step S32).

The large size display device 3 receives the notification to identify the user of the second terminal device 5b and prepare a simple cursor image as the cursor image of the user (step S33), and switch the cursor image of the user on the display screen from a previously displayed general cursor image (the image as illustrated in FIGS. 6 to 8) to the simple cursor image (step S34). A place of the user cursor image on the display screen is moved to a place where a cursor operation of another user is not obstructed (for example, a position outside a window displaying a work content image or a position close to a corner of the display screen) (step S35).

The large size display device 3 performs display synchronization with the second terminal device 5b (step S36) and also performs display synchronization with the first terminal device 5a (step S37). That is, the large size display device 3 notifies the first and second terminal devices 5a and 5b of the simple cursor image after the changeover and a position after movement for the user cursor of the second terminal device 5b. Like the large size display device 3, the first and second terminal devices 5a and 5b also switch the user cursor image of the second terminal device 5b to the simple cursor image and move the simple cursor image to a position at which a cursor operation of another user is not obstructed.

Thereafter, when the user of the second terminal device 5b resumes the cursor operation and the second terminal device 5b detects the cursor operation resumption (step S38), a notification of a cursor operation input is transmitted from the second terminal device 5b to the large size display device 3 (step S39).

The large size display device 3 receives the notification to prepare the original general cursor image as the user cursor image of the second terminal device 5b (step S40) and performs the changeover from the previously displayed simple cursor image to the general cursor image (step S41). The large size display device 3 performs display synchronization with the second terminal device 5b (step S42) and also performs display synchronization with the first terminal device 5a (step S43). Like the large size display device 3, the first and second terminal devices 5a and 5b also return the user cursor image of the second terminal device 5b to the general cursor image.

In this way, a cursor of a user who is actually conducting the collaborative work is more easily discerned and operated by switching a cursor image to a simple display mode on the display screen of the large size display device or each terminal device when a certain user cursor has not been operated for a given time, and moving the cursor to an area where the cursor operation of a user, who is continuing the collaborative work, is not obstructed.

In the above-described example, the changeover from the general cursor image to the simple cursor image has been performed in step S34 and the simple cursor image has been moved to the place where the simple cursor image is not obstructive on the display screen in step S35, but only one of steps S34 and S35 may be performed. Each of the large size display device 3 and the first and second terminal devices 5a and 5b may independently control an operation of changing a display form of a cursor on each display screen.

The display form changing section 12 shown in FIG. 2 controls an operation of changing a display form of a cursor image as described. That is, the display form changing section 12 determines whether or not a cursor operation signal from each user has not occurred for a predetermined time, and changes the display form of the cursor image of the user when the cursor operation signal has not occurred for the predetermined time. The display form changing section 12 determines whether or not the cursor operation signal has been input from each user for the predetermined time, and moves the user cursor image to a predetermined area on the display screen (for example, a lower right corner of the screen) when the cursor operation signal has not been input from each user for the predetermined time.

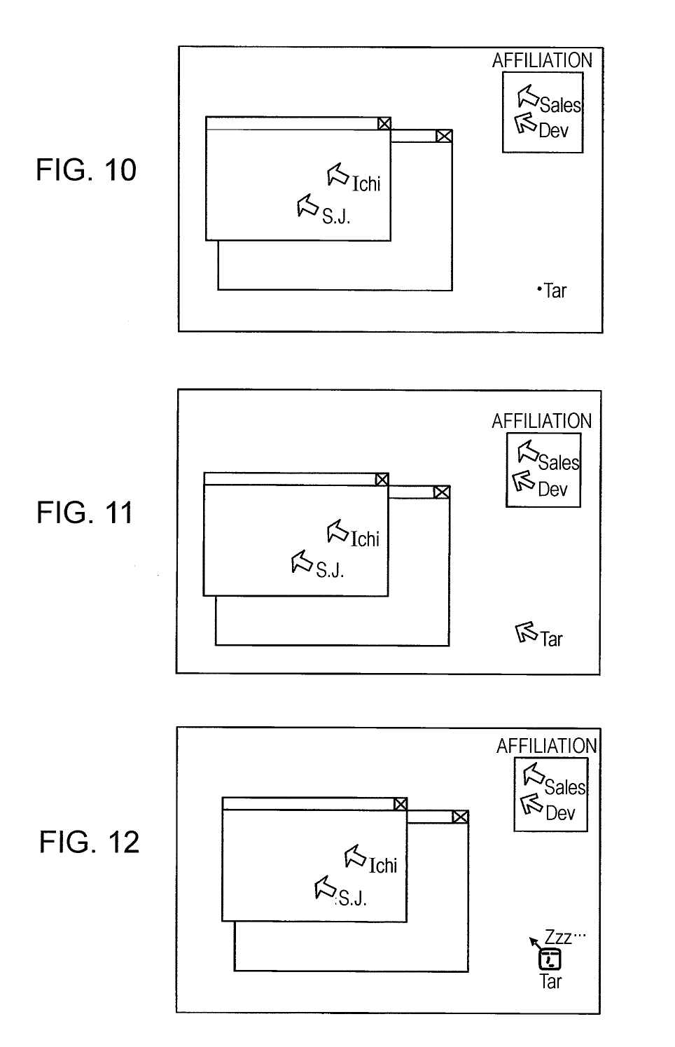

FIG. 10 shows a display screen example of control results shown in FIG. 9 when a cursor operation has not occurred for a given time.

For example, when the cursor operation of the nickname “Tar” has not occurred for a given time in the example shown in FIG. 10, the cursor of “Tar” is changed to a simple cursor image like a small point, and is moved to a place of a lower right corner outside the window where work content is displayed on the display screen. Since the nickname image “Tar” is displayed even in the simple cursor image, it is possible to identify who is the cursor user thereof.

FIG. 11 shows a display screen example of control results shown in FIG. 9 when the cursor operation has been resumed after FIG. 10.

When the cursor operation of the nickname “Tar” has been resumed after the state shown in FIG. 10, the cursor image of “Tar” on the lower right portion of the screen returns to the general cursor image as shown in FIG. 11. At this time, the place of the cursor is in the lower right portion of the screen, but the user can move the cursor from a position thereof to a desired position by a cursor operation.

FIG. 12 shows a display screen example when an avatar image has been used as a simple cursor image as a modified example of the display screen example shown in FIG. 10.

As shown in FIG. 12, when the cursor operation of the nickname “Tar” has not occurred for a given time, the cursor image of “Tar” is changed to an avatar image as a simple cursor image and is moved to a place in the lower right portion of the display screen. In addition to the simple cursor image of “Tar”, an animation such as “Zzz . . . ” which is the onomatopoeic representation for the sound of sleeping may also be displayed so that it can be seen that the cursor is temporarily at rest.

Many other variations can be adopted in a control operation for changing a cursor image display form in response to situations such as a cursor operation or the like. For example, in the case where a large size cursor image obstructs the work of other users when the large size cursor image moves, the cursor image may be changed to a small size cursor image like a point illustrated in FIG. 10 only while each cursor moves and, and the cursor image may be switched to the original large size cursor image only in a stop state.

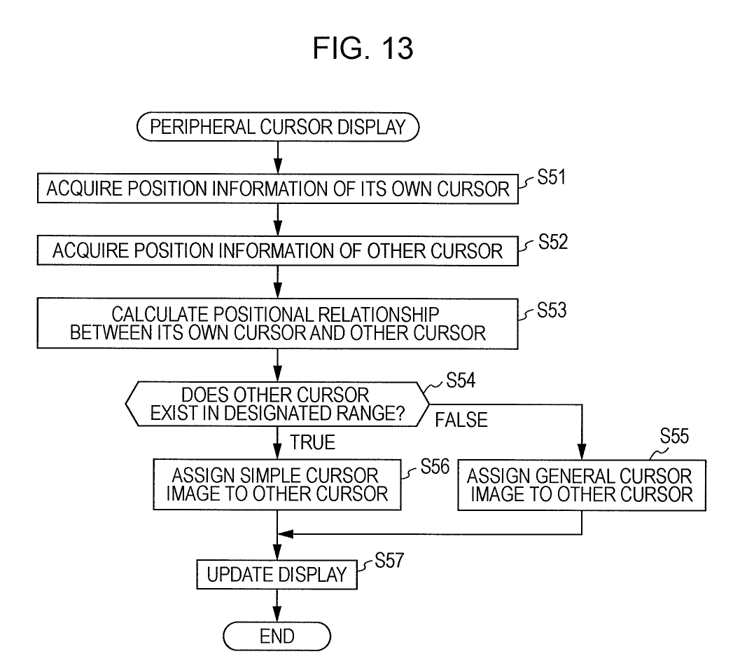

FIG. 13 is a flowchart showing a process flow when a certain terminal device causes another user cursor located close to the user cursor of its own device to be displayed in its simple form.

Each of the terminal devices participating in the collaborative work (for example, each of the large size display device 3 and the terminal devices 5a and 5b) is able to individually perform the control process shown in FIG. 13.

As shown in FIG. 13, each terminal device acquires position information of the user cursor of its own device (step S51) and also acquires position information of other user cursors (step S52). The terminal device calculates a positional relationship between a cursor position of its own user and a cursor position of each of the other users (step S53).

The terminal device determines whether the cursor position of each of the other users exists in a designated range from the cursor position of its own user (step S54). When the cursor position of another user does not exist in the designated range (FALSE in step S54), the terminal device assigns a general cursor image to the cursor of the other user (step S55).

On the other hand, when the cursor position of another user exists in the designated range in step S54 (TRUE in step S54), the terminal device assigns a simple cursor image to the other user cursor (or may not display the cursor image) (step S56), and updates the display screen of its own device (step S57).

Various methods other than a method of performing step S54 may be adopted to determine whether or not another user cursor exists in a designated range. For example, it may be determined whether the distance between another user cursor and its own user cursor is equal to or less than a designated distance, or it may be determined whether or not the cursor of another user exists in the same predetermined area as that of the cursor of its own user or exists in the same window as that where the cursor of its own user performs work. A simple or general cursor image may be assigned to the cursor of the other user when the determination result is negative.

The above-described control process is executed by the cursor image preparing section 19 shown in FIG. 2. That is, the cursor image preparing section 19 may make a display form of the cursor image of its own device user different from a display form of the cursor image of a terminal device of another device user. For example, when a position of the cursor image of its own device user and a position of the cursor image of the other device user exist in a predetermined range on the display screen, it is possible to make the display form of the cursor image of the other device user different from the display form of the cursor image of its own device user.

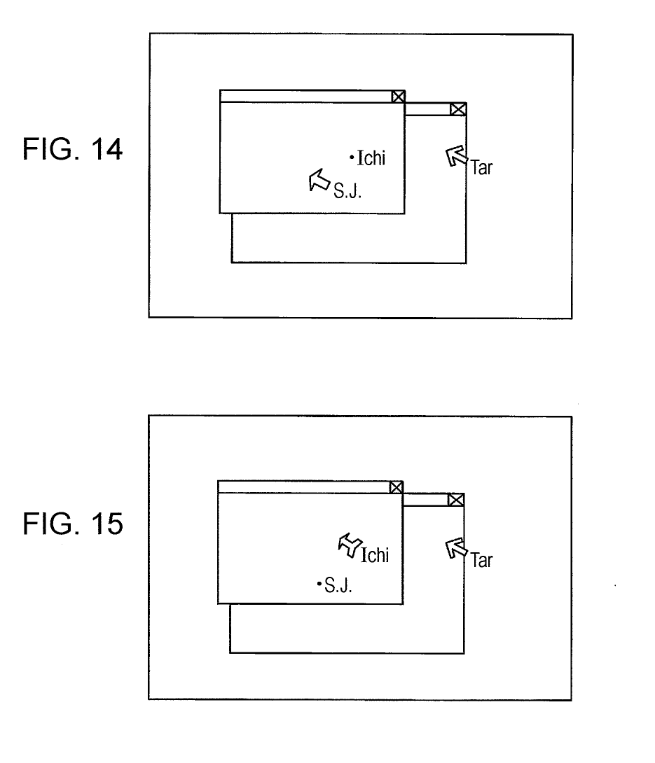

FIGS. 14 and 15 show display screen examples based on the control results of FIG. 13 capable of being arranged in each of different terminal devices.

A terminal device used by a user “S. J” displays a display screen example shown in FIG. 14, and displays the cursor of another user “Ichi” located in the same window as that of the cursor of its own user “S. J” on its own display screen by the simple cursor image of a small point. On the other hand, the terminal device used by the user “Ichi” displays the display screen example shown in FIG. 15, and displays the cursor of another user “S. J” located on the same window as that of the cursor of its own user “Ichi” on its own display screen by the simple cursor image of a small point.

As a modified example of this control process, the cursor of its own user may be set to be easily viewed by constantly displaying a cursor image in which the cursor of its own user is easily viewed and uniformly displaying the cursor of another user in a simple cursor image regardless of a positional relationship with its own user. Alternatively, the cursor of at least one designated user (for example, a conference chairman) may be displayed in a cursor image which is more distinctive than those of other users, regardless of its own device user or other device users. In contrast, a cursor of at least one designated user (for example, a conference participant who does not have the specific right) may be displayed in a cursor image which is not more distinctive than those of other users.

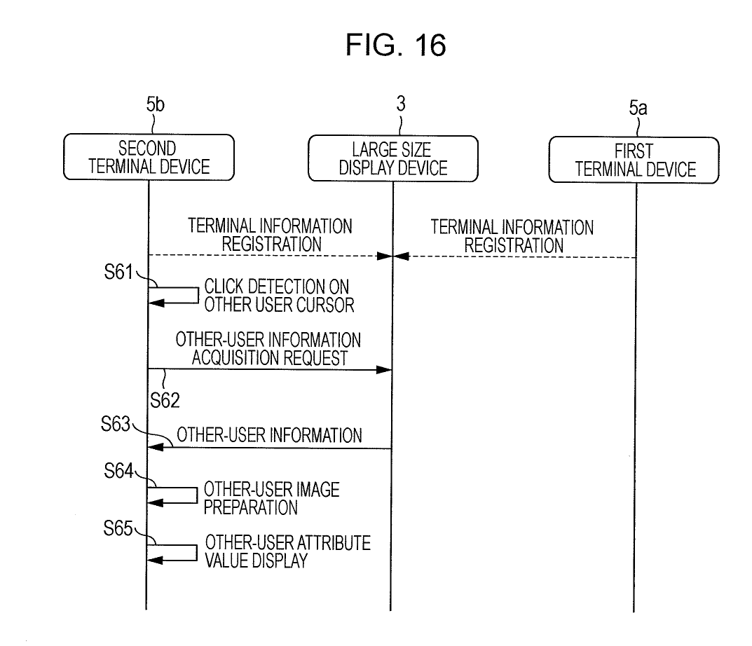

FIG. 16 is a sequence diagram showing the flow of a process in which a user of a certain terminal device refers to detailed information of another user by the terminal device.

The control process shown in FIG. 16 indicates the case where the user of the second terminal device 5b refers to detailed information of the user of the first terminal device 5a as an example. It is assumed that the large size display device 3 is constituted to provide requested detailed information of a user to the second terminal device 5b on the basis of user attribute information.

As shown in FIG. 16, the large size display device registers in advance terminal information of the first terminal device 5a and terminal information of the second terminal device 5b as participant information of a collaborative work. When the user of the second terminal device 5b performs a predetermined operation, for example, a mouse click, by indicating the cursor of another user (for example, the user of the first terminal device 5a), the cursor operation is detected by the second terminal device 5b (step S61) and an acquisition request of user attribute information of the user of the first terminal device 5a clicked is transmitted from the second terminal device 5b to the large size display device (step S62).

In response to the request, the large size display device 3 reads user attribute information of the user of the first terminal device 5a from among user attribute information stored therein and transmits the read information to the second terminal device 5b (step S63). The second terminal device 5b prepares an additional text image indicating user attribute information (that is, a user attribute value of at least one predetermined attribute item) of the user of the first terminal device 5a on the basis of the received user attribute information of the user of the first terminal device 5a (step S64), and displays the additional text image on the display screen of its own device (step S65).

When a user of any one of the large size display device 3 and the terminal devices 5a and 5b has clicked a mouse by indicating the cursor of another user, the above-described control process is executed. This enables each user to visually check another arbitrary user on the display screen of its own terminal device. An additional image indicating this user attribute information is one of cursor image display forms in terms of the invention.

As a modified example, each of the large size display device 3 and the terminal devices 5a and 5b may have user attribute information and display user attribute information of another user directed to a user of its own device on the basis of user attribute information provided in each device.

The above-described control process is executed by the display form changing section 21 shown in FIG. 2. That is, when its own device user makes a click by indicating the cursor of another user, the display form changing section 21 of each terminal device is capable of acquiring a user attribute value of the indicated user and displaying a user attribute value of a predetermined attribute item of the indicated user on its own display screen.

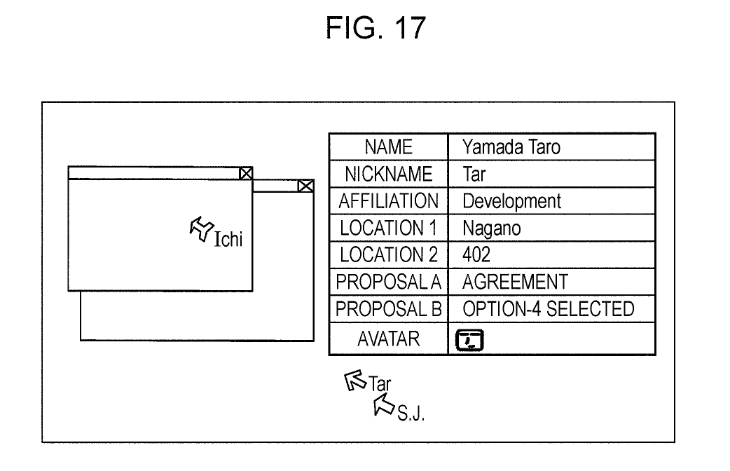

FIG. 17 shows a display screen example as control results shown in FIG. 16.

In the example shown in FIG. 17, user attribute information of the user “Tar” is displayed when the user “S. J” clicks the mouse by indicating the cursor of the other user “Tar” on the display screen of its own terminal device. Attribute items included in the displayed attribute information may be all attribute items and may be only some predefined attribute items.

Designated attribute information of another specific user may be constantly displayed as part of a cursor image.

While the embodiments of the invention have been described, this has been done for illustrative and exemplary purposes only. This is not intended to limit the invention to those embodiments. Other embodiments within the scope of the invention are possible.

The entire disclosure of Japanese Patent Application No. 2009-012535, filed Jan. 23, 2009 is expressly incorporated by reference herein.

What is claimed is:

1. A shared information display device including a work information managing section that receives work content data to be referred to or edited by a plurality of users and cursor operation signals from the plurality of users, a display section that simultaneously displays an image of the work content data and cursor images of the plurality of users on a display screen, and a cursor moving section that moves a cursor image of each user on the display screen in response to a cursor operation signal requesting cursor movement from each user, the shared information display device comprising:
a user attribute information section that acquires or stores user attribute information indicating a user attribute value of each of the plurality of users; and
a cursor image preparing section that prepares a cursor image of each user so that a display form of the cursor image of each user becomes a display form corresponding to a user attribute value thereof on the basis of the user attribute information,
wherein the display section displays the cursor image of each user prepared by the cursor image preparing section on the display screen.

2. The shared information display device according to claim 1,
wherein the cursor image preparing section includes:
a grouping section that classifies the plurality of users into at least two groups on the basis of the user attribute information, and
wherein the cursor image preparing section prepares the cursor image of each user so that display forms of cursor images of users belonging to each group have a common feature corresponding to a common user attribute value of the group.

3. The shared information display device according to claim 1, further comprising:
a display form changing section that determines whether or not the cursor operation signal from each user satisfies a predetermined condition and changes a display form of a cursor image of the user in response to a determination result.

4. The shared information display device according to claim 3,
wherein the display form changing section determines whether or not the cursor operation signal has been input from each user for a predetermined time, and moves a cursor image of the user to a predetermined area on the display screen when the cursor operation signal has not been input from each user for the predetermined time.

5. The shared information display device according to claim 1,
wherein the shared information display device is included in a first terminal device communicable with a second terminal device via a communication network,
wherein the work information managing section receives a cursor operation signal from a first user input to the first terminal device and a cursor operation signal from a second user input to the second terminal device, and
wherein the user attribute information includes a user attribute value of the first user and a user attribute value of the second user.

6. The shared information display device according to claim 5,
wherein the cursor image preparing section makes a display form of a cursor image of the first user different from a display form of a cursor image of the second user.

7. The shared information display device according to claim 5,
wherein the cursor image preparing section makes a display form of a cursor image of the first user different from a display form of a cursor image of the second user when a position of the cursor image of the first user and a position of the cursor image of the second user exist in the same predetermined area on the display screen.

8. The shared information display device according to claim 5,
wherein the display form changing section acquires a user attribute value for a predetermined user attribute item of the second user from the user attribute information and displays the acquired user attribute value on the display screen when the cursor operation signal requesting information regarding a cursor of the second user has been input as the cursor operation signal from the first user.

9. A shared information display method including receiving work content data to be referred to or edited by a plurality of users and cursor operation signals from the plurality of users, simultaneously displaying an image of the work content data and cursor images of the plurality of users on a display screen, and moving a cursor image of each user on the display screen in response to a cursor operation signal requesting cursor movement from each user, the shared information display method comprising:
acquiring or storing user attribute information indicating a user attribute value of each of the plurality of users; and
preparing a cursor image of each user so that a display form of the cursor image of each user becomes a display form corresponding to a user attribute value thereof on the basis of the user attribute information,
wherein the cursor image of each user prepared by the cursor image preparing section is displayed on the display screen.
